(19) United States
(12) Patent Application Publication
(10) Pub. No.: US 2006/0129740 A1
(43) Pub. Date: Jun. 15, 2006

(54) Memory device, memory controller and method for operating the same

(76) Inventors: Hermann Ruckerbauer, Moos (DE); Christian Sichert, Munchen (DE); Dominique Savignac, Ismaning (DE)

Correspondence Address: PATTERSON & SHERIDAN, LLP;Gero McClellan / Infineon Technologies, 3040 POST OAK BLVD.,, SUITE 1500, HOUSTON, TX, 77056, US

(21) Appl. No.: 11/011,466

(22) Filed: Dec. 13, 2004

(51) Int. Cl. G06F 12/06

(52) U.S. Cl. 711/5

(57) ABSTRACT

One embodiment of the present invention provides a memory device comprising a plurality of sets of memory banks, wherein each memory bank includes a memory array and is adapted to be read out in a data access; a plurality of internal data buses and a plurality of internal command and address buses connected to the plurality of sets of memory banks, respectively, such that each set of memory banks is associated with one of the internal data buses and one of the internal command and address buses; a command and address port for receiving command and address data from outside; and a command and address unit to direct the received command and address data to one of the sets of memory banks via the associated command and address bus, depending on the address data; and a data output unit for receiving data read out from one set of memory banks via the respective internal data bus in the data access and for serially outputting the received data.

### BACKGROUND OF THE INVENTION

1. Field of the Invention

The present invention relates to a memory device including memory banks having one or more memory arrays from which data can be read out. The present invention also relates to a memory controller adapted to control a connected memory device. The present invention further relates to methods for controlling such a memory device and such a memory controller.

2. Description of the Related Art

Memory devices usually provide that data stored therein can be read out in a data access, e.g., a number of data is simultaneously read out at a determined row and column of the memory device and output at least partially in series within a burst time interval before the next read address can be applied to the memory device to read out further data in a next data access. With conventional Double-Data-Rate (DDR) technology, the data rate by which data is read out from the memory device is increased as data is output with a rising and a falling edge of the data readout clock. Consequently, the amount of data to be read out within a data access also increases. Thereby, depending on the configuration of the memory device, it is possible that the amount of data read out within a data access is too large and cannot be used by the computer system the memory device is operated in.

Instead, it is desirable that data from different addresses (different columns and/or different rows) would be supplied to the computer system within a data access. However, the minimum time between the data read accesses to different columns of the memory array is limited by the currently used dynamic random access memory (DRAM) technology and by the DRAM array architecture. This means that successive read requests to different columns of the memory device cannot be supplied to the memory array in shorter time than determined by the so called column access cycle time. In conventional memory devices, therefore, read requests to different columns of the memory array cannot be applied faster than the column access cycle time wherein an amount of data is serially output during the whole column access cycle time. However, reducing the amount of data output within the column access cycle time would result in a time gap between the last data bit to be output and the time at which the next data access delivers data to be output from the memory device.

Therefore, there is a need for a memory device in which the data to be output as a result of a read access to one memory address can be reduced without loosing capacity to read out further data from the memory device. Also, there is a need for a memory controller which is able to operate such a memory device. Furthermore, there is a corresponding need for methods for operating a memory device and a memory controller according to the above-mentioned aspects.

### SUMMARY OF THE INVENTION

According to a first aspect of the present invention, a memory device is provided including a plurality of sets of memory banks wherein each memory bank includes a memory array. Each memory bank is adapted to be read out in a single data access. Furthermore, a plurality of internal data buses connected to the sets of memory banks are provided, such that each set of memory banks is associated with one of the internal data buses. By means of a data output unit, data read out from the one set of memory banks via the respective internal data bus in the data access is read out and output serially according to the data access.

According to a further embodiment of the present invention, the memory device may further comprise a command and address port for receiving command and address data from outside, and a plurality of internal command and address buses connected to the sets of memory banks such that each set of memory banks is associated with one of the internal command and address buses.

Such a memory device may include separated arrangements of sets of memory banks, each having its own internal data buses and internal command and address buses. All of the command and address buses are connected to the command and address unit which directs the received command and address data to the respective set of memory banks. Similarly, the data buses are separately connected to the data output unit in which the data read out during the data access are buffered and serially output. Buffering and outputing data serially may be performed as commonly known for data accesses. The physically separated arrangements of the sets of memory banks (each connected to its own data and command bus and address bus) allow the data banks to be operated separately substantially without considering any minimum access time, such as the column-to-column delay (tCCD), which defines the time between successive column accesses.

Each memory bank may be adapted to allow successive data accesses not faster than in a column access cycle time, wherein the data output unit is operable to output the data provided during the data access from one of the sets of the memory banks in an output time interval which is shorter than the column access cycle time. Thereby, it is possible to overcome the restriction of the minimum access times given in the memory device.

The data output unit may be operable to output the data received from one of the sets of memory banks in a time which corresponds to the column access cycle time divided by the plurality of sets of memory banks. Thus, data from different addresses may be combined to the output data which can be output within a single data output sequence. In the case of burst data (data to be output within a burst), the output then includes the data from different addresses provided from different sets of memory banks successively addressed in a time shorter than the column access cycle time.

To direct the command and address data to the addressed set of memory banks, the command and address unit may comprise a demultiplexer. The demultiplexer may be directly coupled to the command and address port. Furthermore, the demultiplexer may include a control input which is coupled to at least one address bit of the address data received.

According to another aspect of the present invention, a memory controller for controlling a memory device is provided. The memory device which is connectable to the memory controller includes a plurality of sets of memory banks wherein a plurality of memory portions are contained within each memory bank. The memory portions in one memory bank may be successively read out in a data access with a column access cycle time. The memory controller comprises a command and address data port for supplying command and address data to the memory device. By means of a control unit, requests including memory addresses from where data is to be read out in a data access, is received and queued. The control unit is adapted to sort the requests with respect to their addresses so that two addresses associated to different sets of memory banks in the memory device are applied to the memory device within a short time interval which is shorter than the column access cycle time.

Thereby, a memory controller optimizes the data access to the memory device connected thereto by combining the data of different memory addresses which conventionally cannot be accessed in a single data access.

Furthermore, the control unit may be adapted so that the short time interval is set to a time determined by the column access cycle time divided by the plurality of sets of memory banks in the memory device. Thereby, a plurality of data accesses to the memory device may be achieved that are performed within the column access cycle time if different sets of memory banks are addressed.

The control unit may be adapted to sort the requests with respect to their addresses so that two addresses associated to the same set of memory banks in the memory device are applied to the memory device within a time interval equal to or larger than the column access cycle time so that no conflict in accessing the memory banks of one set occurs.

According to another aspect of the present invention, a method for operating a memory device including a plurality of sets of memory banks is provided. Each memory bank includes a memory array. Each set of memory banks is adapted to be read out in a data access, i.e., to output data provided for a read out in a data access. The method comprises the steps of receiving command and address data from outside, directing the received command and address data to one of the sets of memory banks depending on the address data, receiving of the data read out from the one set of memory banks in the data access, and serially outputting the received data according to the data access.

According to another embodiment of the present invention, successive data accesses may be allowed after a column access cycle time, wherein the data provided during the data access is output from one of the sets of the memory banks in an output time interval which is shorter than the column access cycle time. Utilizing such a method, the command and address data may be provided to one memory device faster than conventional methods, since minimum access times for addressing the memory device can be ignored.

In one embodiment, the data received from one of the sets of memory banks may be output within a time which corresponds the column access cycle time divided by the number of sets of memory banks.

The command and address data may be demultiplexed depending on at least one address bit of the address data received.

According to another aspect of the present invention, a method for operating a memory controller for controlling one memory device including a plurality of sets of memory banks is provided. A plurality of memory portions is contained within each memory bank, and the memory portions in one memory bank may be successively read out in a data access within a column access cycle time. The method comprises the steps of receiving and queuing read requests including memory addresses from where data is to be read out in a data access, sorting the addresses so that two addresses associated to different sets of memory banks in the memory device are applied to the memory device within a short time interval which is shorter that the column access cycle time, and supplying command and address data to a memory device.

Such a method for operating the memory controller allows an optimized access of the memory device to request data in a data access wherein the read requests sent to the memory device are provided faster than the column access cycle time to request data to be read out from the memory device.

The step of sorting of the requests with respect to their addresses may be performed so that the short time interval is set to a time determined by the column access cycle time divided by the number of sets of memory banks in the memory device. This allows for rapidly sending read requests to the memory device wherein each read request may initiate a burst read-out in one set of memory banks within the memory device and wherein the data provided by each set of memory banks is serially output.

### BRIEF DESCRIPTION OF THE DRAWINGS

These and other objects and features of the present invention will become clear from the following description taken in conjunction with the accompanying drawings in which:

FIG. 1 is a block diagram representing a memory device having a plurality of sets of memory banks according to one embodiment of the present invention; and

FIG. 2 is a block diagram of a memory controller according to another embodiment of the present invention.

### DETAILED DESCRIPTION OF THE PREFERRED EMBODIMENT

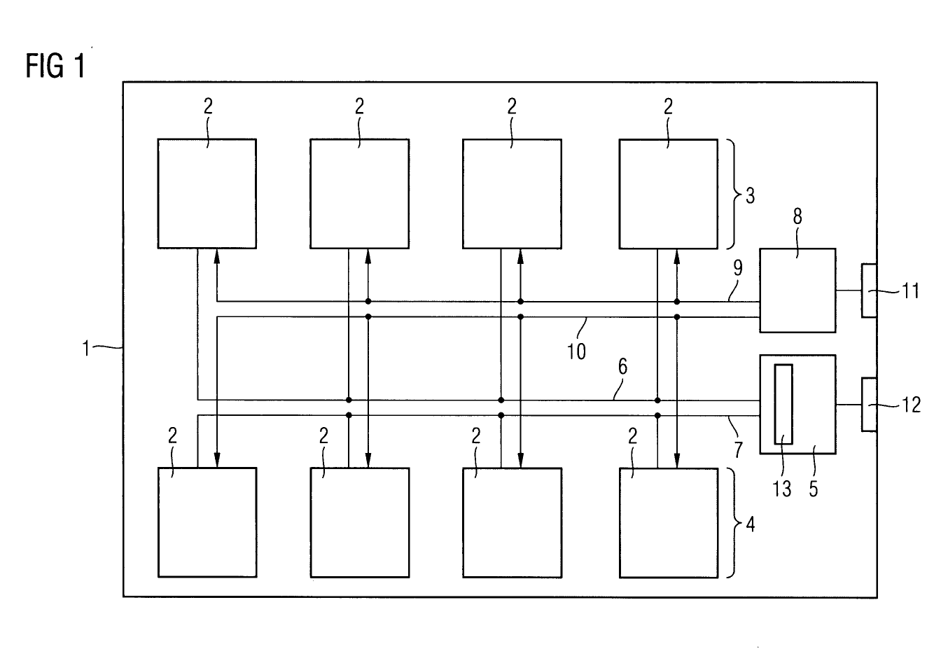

In FIG. 1, a block diagram of a memory device 1 according to one embodiment of the present invention is depicted. The memory device 1 includes a plurality of memory banks 2 which are grouped into different sets of memory banks (also referred herein as “memory banks set”). In the given example, a first set 3 of memory banks 2 and a second set 4 of memory banks 2 are depicted, each set of memory banks including four memory banks 2. The memory banks 2 include one or more memory arrays and may be equal in size. However, different sizes of memory arrays may be utilized. The memory arrays may include DRAM memory cells, thereby forming a DRAM memory. Other types of memory cells are also applicable if they have access time restrictions as is usually the case in DRAM memory cells.

The memory arrays comprise a matrix of DRAM memory cells arranged on wordlines and bitlines (or row lines and column lines) by which the DRAM memory cells can be selected and addressed. In a read access, a number of data bits are simultaneously read out in a pre-fetch operation and are transferred to an output register 13 from which the read out data is serially output, e.g., in a data burst in which the data is serially output in a number of cycles without applying address information to the memory device.

The data rate by which the data is output is determined by the memory device architecture. In a DDR-2 memory device, for instance, 64-bit data are simultaneously read out in the memory bank in a pre-fetch in which the respective address memory cells are simultaneously addressed and provided to the output registers. If the data width by which the data is output is 16 bits, the data is output by four clock edges within 2 clock cycles.

In a DDR-3 memory device, the number of data bits read out simultaneously is doubled to 128 bits which are simultaneously pre-fetched and forwarded to the output register 13 from which the data is serially output within 4 clock cycles having 8 clock edges (provided that the memory device comprises 16 data outputs). With another increase of data to be read out within a data access, the number of available data in the output registers increases to 256 bits or higher which has to be read out within the respective data access. The 256-bit data from one memory address usually represent an amount of data which is too much to be efficiently processed by a processor of a computer system, for example. Particularly, instruction data read out from the memory is usually provided from different memory addresses which are substantially distributed in a larger portion of the memory array or spread over the different memory banks 2. Thus, data read out with a data access usually cannot be fully used by a connected processor, and conventionally, unused data has been discarded, which reduces the performance of the memory device, as unused data is still provided at the data outputs of the memory device 1.

According to one embodiment of the present invention, the memory banks 2 are separated into two sets of memory banks (e.g., set 3 and set 4). Each set of memory banks is connected to a data output unit 5 via a separate internal data bus 6, 7, wherein a first data bus 6 connects the output unit to the first set 3 of the memory banks 2 and a second internal data bus 7 connects the second set 4 of memory banks 2 to the output unit 5.

A command and address unit 8 is provided which supplies command and address data to the memory banks 2. The first set 3 of memory banks 2 is connected via a first command and address bus 9 with the command and address unit 8, and the second set 4 of memory banks 2 is connected via the second command and address bus 10 with the command and address unit 8. The command and address unit 8 is coupled to a command and address port 11. The command and address port 11 may include command and address input pins (not shown) and input latches (not shown) to receive the respective command and address signal from a memory controller and to forward the received command and address signals to the command and address unit 8.

Similarly, the output unit 5 is connected to a data output port 12 which comprises data input/output pins (or I/O pins) and I/O drivers to receive and to transmit data. The number of data I/O pins (not shown) may be provided according to the data width to be output in parallel.

Usually, in conventional memory devices, only one internal data bus and one internal command and address bus is available, and thus, a column access cycle time exists which defines a minimum time period between two successive data accesses. A data access is performed by applying a column address to demultiplexer switches included in the memory banks to couple the data to be read out to the internal data bus line. The column access cycle time is substantially determined due to the load of the internal data bus lines and due to the driving capacity of a secondary sense amplifier which amplifies the data read out from the memory array. In conventional DRAM devices, the column access cycle time may be determined by the so-called column-to-column delay which is abbreviated as the time t_{CCD}. The column-to-column delay indicates the time which must be regarded when changing the column address to read out data from another memory address without changing the respective row address (word address). To provide a more flexible burst data read out scheme, a plurality of sets of memory banks 2 is therefore provided according to one embodiment of the invention, and each set of memory bank may be connected to a separate command and address bus (e.g., command and address bus 9, 10) and a separate data bus (e.g., data bus 6, 7), which therefore may be operated independently.

To direct the respective command and address signals received via the command and address port 11 from a memory controller to the respective memory banks set 3, 4, the command and address unit 8 includes a demultiplexer (not shown) which directs the command and address signals to the first command and address bus 9 or the second command and address bus 10, respectively. A control input of the demultiplexer of the command and address unit 8 is connected to at least one bit of the address signals or to a separate control signal as the different memory banks 2 or the different sets 3, 4, of memory banks 2 are associated to different memory addresses. Data read out from the memory banks 2 are transferred to the output unit 5 in the pre-fetch and gathered in the output register 13 from which the data is serially output as a data burst. The outputting of the data may be performed utilizing a predetermined number of data output pins in a number of clock cycles depending on the respective double data rate technology and a set burst length which may be set individually.

According to embodiments of the invention, this architecture of the memory device allows for addressing different addresses in different sets of memories without being restricted by the column access cycle time within which the respective data bus lines are occupied by a preceding data burst read out. By applying command and address signals to the command and address port 11 by a memory controller which controls the operation of the memory device 1, for example, the architecture of the memory device according to one embodiment of the present invention may be utilized to optimize the data read out from the memory device 1. For instance, the command and address signals may be applied to address a memory address in the first set 3 of memory banks 2, wherein as a consequence, data is output on the first data bus 6 to be stored in the output register 13. Without awaiting the column access cycle time to be passed, command and address signals for addressing a next memory address in the second set 4 of memory banks 2 may be applied to the command and address port 11 which is directed by the command and address unit 8 via the second command and address bus 10 to the second set 4 of memory banks 2. The addressed memory in the second set 4 of memory banks 2 then outputs the data to be read out via the second data bus 7 to the output register 13. The data from the first memory banks set 3 and the second memory banks set 4 contained in the output register 13 may be serially output via the output data port 12 as a burst. Thus, data from different memory addresses may be combined to be output as one data burst if the data from the different memory addresses were read out from different sets of memory banks 2.

To signal what amount of data is to be read out in the following burst, the memory device 1 may receive a command which indicates the length of the pre-fetch. For instance, a command signal may indicate that another command and address signal referring to a memory address in another set of memory banks will be applied to the command and address port within a time shorter than the column access cycle time, and thus only a reduced number of data will be pre-fetched so that with the successive command and address data, another data is provided for the next burst readout. Otherwise, the pre-fetch will comprise a data which fully fills the output register 13.

The minimum time in which the two successive command and address signals may be applied to the command and address port 11 merely depends on the set-up and hold time of the command and address unit 8 to reliably direct the command and address signals to the respective command and address bus lines. In the embodiment shown in FIG. 1, the time between succeeding command and address signals applied to the command and address port 11 may equal half the time of the column access cycle time (e.g., when the column access cycle time equals 5 nsec, the time between the command and address signals may be 2.5 nsec).

In other embodiments, more than two sets of memory banks may be provided, and each memory banks set may be connected via a separate command and address bus and a separate data bus so that the sets of memory banks may be operated independently. Depending on the command and address unit 8, which may be correspondingly adapted to direct the command and address signals received depending on at least one of the address bits to one of the sets of memory banks. For a given a column access cycle time predetermined by the manufacturing technology and design of the memory device, all sets of memory banks may be addressed by the different command and address signals within one cycle time defined by the column access cycle time divided by the number of different sets of memory banks.

For the data to be output within a data burst to be available in the output register 13, sufficient time has to be provided between the command and address signals addressing a memory address of a specified set of memory banks 2 and the time at which the respective data is buffered in the output register and can be output as a part of the burst data.

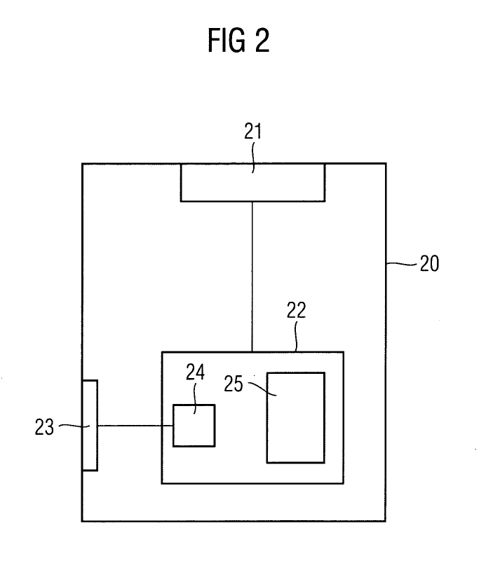

In FIG. 2, a block diagram of a memory controller 20 according to another embodiment of the present invention is depicted. The memory controller 20 may be utilized in a computer system to generate the operating signals to store and to read out data to and from the memory device according to requests of a processor unit (not shown). The memory controller 20 comprises a command and address data port 21 to supply command and address data to the memory device connected thereto. The memory controller 20 further includes a control unit 22 for receiving requests via a request port 23 (e.g., from a processor unit) and for queuing the read requests including memory addresses in a request queue 24. The control unit 22 further comprises a sorting unit 25 which sorts the requests with respect to their memory addresses in the queue 24 so that two addresses associated with different sets of memory banks in the memory device are applied to the memory device within a time interval which is shorter than the column access cycle time of the memory device. Thus, data from different memory addresses may be read out from the memory device in a shorter time compared to the case that only data from one memory address (one row address and one column address) is output within one burst. The control unit 22 may be further adapted to sort the addresses so that two addresses associated to the same set of memory banks, e.g., the memory addresses that are physically located within the same memory array, are applied to the memory device within a time interval equal or larger than the column access cycle time with respect to the column-to-column access delay time t_{CCD}. Usually, in an initialization phase during start-up and such like, the memory controller 20 is informed about the connected memory devices, and thus, the control unit 22 knows how many different sets of memory banks 2 are included in the memory devices and the respective column access cycle time (which is the column-to-column delay time). In view of this information, the control unit 22 may determine a cycle time with which one of the memory devices may be supplied with command and address data addressing memory addresses in different sets of memory banks. However, the time for addressing memory addresses in the same set of memory banks 2 is not reduced.

Additionally, the control unit 22 may create command signals and provide them the memory device together with the addresses of the requests. The command signal may indicate whether the delivered address refers to a memory address from which all available data shall be read out or whether command and address data will be supplied after a short time to read out data from another memory address which then are added to the data previously prefetched and then entirely output in a data sequence.

While the foregoing is directed to embodiments of the present invention, other and further embodiments of the invention may be devised without departing from the basic scope thereof, and the scope thereof is determined by the claims that follow.

What is claimed is:

1. A memory device, comprising:
a plurality of sets of one or more memory banks, wherein each memory bank comprises a memory array and is adapted to be read out in a data access;
a plurality of internal data buses respectively connected to the plurality of sets of memory banks, wherein each set of memory banks is associated with one internal data bus; and
a data output unit for receiving data read out from one set of memory banks via the respective internal data bus in the data access and for serially outputting the received data.

2. The memory device of claim 1, wherein each memory bank is configured to allow successive data accesses after a column access cycle time, wherein the data output unit is operable to output the data provided during the data access from one of the sets of the memory banks in an output time which is shorter than the column access cycle time.

3. The memory device of claim 2, wherein the memory array comprises DRAM memory cells.

4. The memory device of claim 3, wherein each memory bank is configured to be accessed by a row and column address, wherein the column access cycle time represents a minimum time in which successive column addresses is accessed.

5. The memory device of claim 4, wherein the data output unit is operable to output the data received from one of the sets of memory banks within a time which corresponds to the column access cycle time divided by a number of sets of memory banks.

6. The memory device of claim 1, further comprising:
a command and address port for receiving command and address data;
a plurality of internal command and address buses connected respectively to the plurality of sets of memory banks, wherein each set of memory banks is associated with one internal command and address bus;
a command and address unit for directing the received command and address data to one of the sets of memory banks via the associated command and address bus, depending on the address data.

7. The memory device of claim 6, wherein the command and address unit comprises a demultiplexer.

8. The memory device of claim 7, wherein the demultiplexer is directly coupled to the command and address port.

9. The memory device of claim 8, wherein the demultiplexer includes a control input coupled to receive at least one address bit of the address data received.

10. A memory controller for controlling a memory device, comprising:
a command and address data port for supplying command and address data to the memory device; and
a control unit for receiving and queuing read requests indicating memory addresses from where data is to be read out in a data access, wherein the control unit is configured to sort the read requests with respect to the respective memory addresses so that two addresses associated with different sets of memory banks in the memory device are applied, via the command and address data port to the memory device within a time interval which is shorter that a column access cycle time.

11. The memory controller of claim 10, wherein the memory device comprises a plurality of sets of memory banks, wherein each memory bank includes a plurality of memory portions and wherein the memory portions in one memory bank can be successively read out in one data access within the column access cycle time.

12. The memory controller of claim 11, wherein the control unit is configured with the time interval which is determined by the column access cycle time divided by a number of sets of memory banks in the memory device.

13. The memory controller of claim 10, wherein the control unit is configured to sort the read requests with respect to the respective memory addresses so that two addresses associated to the same set of memory banks in the memory device are applied to the memory device within a second time interval which is at least equal to the column access cycle time.

14. A method for operating a memory device having a plurality of sets of memory banks, comprising:
receiving command and address data;
directing the received command and address data to one of a plurality of sets of memory banks of the memory device depending on the address data, wherein each memory bank includes a memory array which is adapted to be read out in a data access;
receiving data read out from the one set of memory banks in the data access; and
serially outputting the received data.

15. The method of claim 14, wherein successive data accesses are allowed after a column access cycle time, and wherein the data provided during the data access is output from one of the sets of the memory banks in an output time interval which is shorter than the column access cycle time.

16. The method of claim 15, wherein the data received from one of the sets of memory banks is output within a time which corresponds the column access cycle time divided by a number of sets of memory banks.

17. The method of claim 14, wherein the command and address data is demultiplexed depending on at least one address bit of the address data received.

18. A method for operating a memory controller for controlling a memory device, comprising:
receiving and queuing read requests indicting memory addresses from where data is to be read out in a data access;
sorting the read requests with respect to the respective memory addresses such that two addresses associated with different sets of memory banks in the memory device are applied to the memory device within a first time interval which is shorter than a column access cycle time; and
supplying command and address data to the memory device.

19. The method of claim 18, wherein the first time interval is set to a time determined by the column access cycle time divided by a number of sets of memory banks in the memory device.

20. The method of claim 19, wherein the sorting of the read requests with respect to the respective memory addresses is performed such that two addresses associated with the same set of memory banks in the memory device are applied to the memory device within a second time interval which is at least equal to the column access cycle time.
